(19) United States
(12) Patent Application Publication
(10) Pub. No.: US 2009/0246443 A1
(43) Pub. Date: Oct. 1, 2009

(54) SIMULTANEOUS TWO-PHOTON ABSORPTION THREE-DIMENSIONAL OPTICAL RECORDING MEDIUM AND SIMULTANEOUS TWO-PHOTON THREE-DIMENSIONAL OPTICAL RECORDING METHOD

(75) Inventors: Masaharu AKIBA, Kanagawa (JP); Eri TAKAHASHI, Kanagawa (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 12/412,662

(22) Filed: Mar. 27, 2009

(30) Foreign Application Priority Data
Mar. 28, 2008 (JP) 2008-088552

(51) Int. Cl. B32B 3/02

(52) U.S. Cl. 428/64.8; 428/64.4

(57) ABSTRACT

Provided is a simultaneous two-photon absorption three-dimensional optical recording medium for recording three-dimensionally record pits in the recording medium by simultaneous two-photon absorption and reading these recorded record pits, which has a multilayer structure prepared by laminating recording layers and intermediate layers, wherein information is recorded on the recording layers by simultaneous two-photon absorption, the intermediate layers do not change by a recording light, and sensitivities of a part of or all of the recording layers are different.

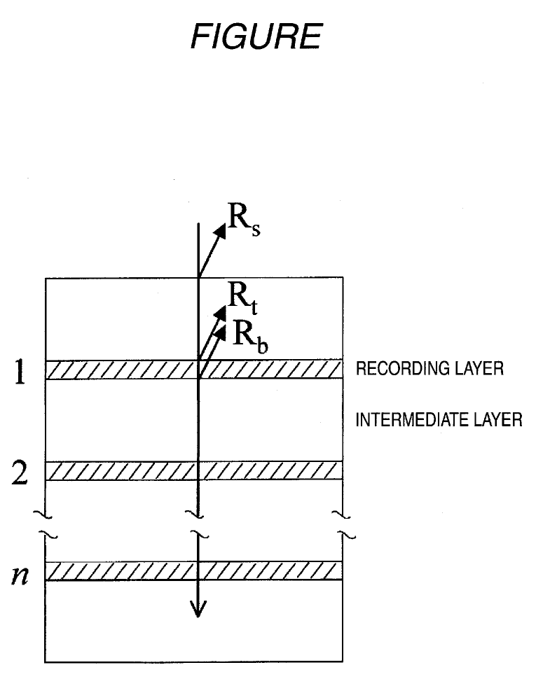

### BACKGROUND OF THE INVENTION

1. Field of the Invention

The present invention relates to a simultaneous two-photon absorption three-dimensional optical recording medium for recording three-dimensionally record pits in the recording medium by simultaneous two-photon absorption and reading these recorded record pits. Specifically, the invention relates to a simultaneous two-photon absorption three-dimensional optical recording medium that does not lower in recording sensitivities at the deep part by increasing sensitivities of the recording layers in the depth direction even when recording light that weakens at a deep part is used, and the invention also relates to a simultaneous two-photon three-dimensional optical recording method.

2. Description of the Related Art

In general, the non-linear optical effect means a non-linear optical response proportional to the square, cube or higher power of photoelectric field applied. As second order non-linear optical effects proportional to the square of photoelectric field applied, second harmonic generation (SHG), optical rectification, photo-refractive effect, Pockels effect, parametric amplification, parametric oscillation, light sum frequency mixing, and light difference frequency mixing are known. As third order non-linear optical effects, third harmonic generation (THG), optical Kerr effect, self-induced refractive index change and two-photon absorption are exemplified.

As the non-linear optical materials exhibiting these non-linear optical effects, a variety of inorganic materials have been found until now. However, it has been very difficult to use inorganic materials in practice for the reason that what is called molecular design to optimize desired non-linear optical characteristics or various physical properties necessary to manufacture a device is difficult. On the other hand, organic compounds are not only capable of optimization of desired non-linear optical characteristics by molecular design but also control of other various physical properties, and the possibility of practical use is high. Thus, organic materials are attracting public attention as promising non-linear optical materials.

In recent years, of the non-linear optical characteristics of organic compounds, third order non-linear optical effect, in particular, non-resonant two-photon absorption, is becoming the object of public attention. Two-photon absorption is a phenomenon such that a compound is excited by the absorption of two photons simultaneously. The case where two-photon absorption occurs in the energy region having no (linear) absorption band of the compound is called non-resonant two-photon absorption. In the following description, “two-photon absorption” means “non-resonant two-photon absorption” even when not especially indicated. Further, “simultaneous two-photon absorption” is sometimes referred to as merely “two-photon absorption” by omitting “simultaneous”.

The efficiency of non-resonant two-photon absorption is proportional to the square of photoelectric field applied (quadratic dependency of two-photon absorption). Accordingly, when a laser is irradiated on a two-dimensional plane, two-photon absorption occurs only at the position having high electric field strength of the center part of laser spot, and two-photon absorption does not occur at all at the peripheral part having weak electric field strength. On the other hand, in a three-dimensional space, two-photon absorption occurs only in the region having large electric field strength at the focus where the laser rays are converged through a lens, and two-photon absorption does not take place at all in the region being off the focus for the reason that the electric field strength is weak. As compared with the linear absorption where excitation occurs at all the positions in proportion to the strength of photoelectric field applied, in the non-resonant two-photon absorption, since excitation takes place at only one point in the space due to quadratic dependency, spatial resolution is extraordinarily improved.

In general, in the case of inducing non-resonant two-photon absorption, a short pulse laser in the near infrared region having wavelength longer than the wavelength region where the (linear) absorption band of a compound is present and the absorption of the compound is not present is used in many cases. Since a near infrared ray in what is called a transparent region is used, excited light can reach the inside of a sample without being absorbed or scattered, and one point inside the sample can be excited due to quadratic dependency of non-resonant two-photon absorption with extremely high spatial resolution.

Accordingly, if polymerization can be brought about with the excited energy obtained by non-resonant two-photon absorption, polymerization can be caused at an arbitrary position in a three-dimensional space, and also this enables application to three-dimensional optical recording media, and fine three-dimensional formative materials, which are considered to be ultimate high density recording media.

From such aiming, trials to cause locally photopolymerization only at a limited area by non-resonant two-photon absorption to perform high density recording are disclosed in JP-A-2004-292475 (The term “JP-A” as used herein refers to an “unexamined published Japanese patent application”.) and JP-A-2004-292476. However, the photopolymerizable binders used in these techniques disclosed therein are not binders capable of forming crosslinking, therefore, the recording parts in the binders transfer (displace), which gives rise to a problem such that reduction of recording quality is caused to a three-dimensional pit recording system which is required to have high spatial positional accuracy.

As a specific example of three-dimensional optical recording medium, a two-photon recording medium comprising recording layers of a multilayer structure is disclosed in Opt. Eng., Vol. 40 (10), p. 2247 (2001). However, there is a problem in the technique such that the quantity of light for recording lowers at the deep part due to reflection at the interfaces of the layers, and recording sensitivity is reduced.

### SUMMARY OF THE INVENTION

An object of the invention is to prevent reduction of recording sensitivity ascribable to attenuation of recording light at a deep part in a two-photon absorption three-dimensional optical recording medium having a multilayer structure.

As a result of earnest investigations, the present inventors have found a useful method of increasing the sensitivities of recording layers in the depth direction in a two-photon absorption three-dimensional optical recording medium of recording three-dimensionally record pits inside the recording medium by means of simultaneous two-photon absorption and reading the record pits, by which recording sensitivity at a deep part can be prevented from reducing even when recording light of attenuating at a deep part is used, thus the above object can be achieved.

That is, the object of the invention has been achieved by the following means.

1. A simultaneous two-photon absorption three-dimensional optical recording medium for recording three-dimensionally record pits in the recording medium by simultaneous two-photon absorption and reading these recorded record pits, which has a multilayer structure prepared by laminating recording layers and intermediate layers, wherein information is recorded on the recording layers by simultaneous two-photon absorption, the intermediate layers do not change by a recording light, and sensitivities of a part of or all of the recording layers are different.
2. The simultaneous two-photon absorption three-dimensional optical recording medium as described in the above 1, wherein

the sensitivities of a part of or all of the recording layers are increasing from a nearer side to a farther side in an advancing direction of a recording light.

3. The simultaneous two-photon absorption three-dimensional optical recording medium as described in the above 1 or 2, wherein

sensitivities of adjacent two recording layers are the same, or a sensitivity of the recording layer on the farther side in the advancing direction of the recording light is higher than a sensitivity of the recording layer on the nearer side in the advancing direction of the recording light.

4. The simultaneous two-photon absorption three-dimensional optical recording medium as described in any one of the above 1 to 3, wherein

a sensitivity of a n^{th} recording layer in the advancing direction of the recording light is higher than a sensitivity of the nearest recording layer in the advancing direction of the recording light by X times or more, wherein X is represented by the following expression (1):

X=[2−(1−Rₛ)(1−Rₜ)ⁿ(1−R_{b})ⁿ⁻¹]/(1+Rₛ+Rₜ−Rₜ−Rₜ) (1)

wherein

Rₛ represents a reflectance at a surface of the medium and is a real number of 0 or greater and 1 or smaller;

Rₜ represents a reflectance at a top face of the recording layer in the advancing direction of the recording light and is a real number of 0 or greater and 1 or smaller;

R_{b} represents a reflectance at a bottom face of the recording layer in the advancing direction of a recording light and is a real number of 0 or greater and 1 or smaller; and

n is an integer indicating to be the n^{th} recording layer in the advancing direction of the recording light.

5. The simultaneous two-photon absorption three-dimensional optical recording medium as described in any one of the above 1 to 4, wherein

the recording layers contain at least a two-photon absorption compound, a polymerization initiator, a polymerizable compound, and a polymer binder.

6. The simultaneous two-photon absorption three-dimensional optical recording medium as described in any one of the above 1 to 4, wherein

the recording layers contain at least a two-photon absorption compound, a dye precursor and a polymer binder.

7. The simultaneous two-photon absorption three-dimensional optical recording medium as described in any one of the above 3 to 5, wherein

the sensitivity of the recording layer on the farther side in the advancing direction of the light is increased by increasing a concentration of a two-photon absorption compound.

8. The simultaneous two-photon absorption three-dimensional optical recording medium as described in any one of the above 3 to 5, wherein

the sensitivity of the recording layer on the farther side in the advancing direction of the light is increased by increasing a concentration of a polymerization initiator.

9. The simultaneous two-photon absorption three-dimensional optical recording medium as described in any one of the above 3 to 5, wherein

the sensitivity of the recording layer on the farther side in the advancing direction of the light is increased by increasing a concentration of a polymerizable compound.

10. The simultaneous two-photon absorption three-dimensional optical recording medium as described in any one of the above 3 to 5, wherein

the sensitivity of the recording layer on the farther side in the advancing direction of the light is increased by increasing concentrations of all of or any two of a two-photon absorption compound, a polymerization initiator and a polymerizable compound.

11. The simultaneous two-photon absorption three-dimensional optical recording medium as described in the above 6, wherein

the sensitivity of the recording layer on the farther side in the advancing direction of the light is increased by increasing a concentration of the dye precursor, or by increasing concentrations of both of the two-photon absorption compound and the dye precursor.

12. A method of simultaneous two-photon three-dimensional optical recording, comprising:

inducing a simultaneous two-photon absorption on the simultaneous two-photon absorption three-dimensional optical recording medium as described in the above any one of 1 to 11 to record information three-dimensionally.

### BRIEF DESCRIPTION OF THE DRAWING

FIGURE is a drawing for explaining a multilayer optical recording medium, wherein

Rₛ represents the reflectance at the surface of the medium,

Rₜ represents the reflectance at the top face of the recording layer in the advancing direction of a recording light, and

R_{b} represents the reflectance at the bottom face of the recording layer in the advancing direction of a recording light

### DETAILED DESCRIPTION OF THE INVENTION

The simultaneous two-photon absorption three-dimensional optical recording medium in the invention will be described in detail below.

### A Simultaneous Two-Photon Absorption Three-Dimensional Optical Recording Medium Comprising Multilayer of Recording Layers:

The example of the structure of a simultaneous two-photon absorption three-dimensional optical recording medium comprising a plurality of recording layers of the invention is shown in the FIGURE.

In the FIGURE, Rₛ represents the reflectance at the surface of the medium and is a real number of 0 or greater and 1 or smaller; Rₜ represents the reflectance at the top face of the recording layer in the advancing direction of a recording light and is a real number of 0 or greater and 1 or smaller; R_{b} represents the reflectance at the bottom face of the recording layer in the advancing direction of a recording light and is a real number of 0 or greater and 1 or smaller; and n represents an integer indicating what order of the recording layer is it in the advancing direction of a recording light.

The simultaneous two-photon absorption three-dimensional optical recording medium in the invention is a two-photon absorption three-dimensional optical recording medium for recording three-dimensionally record pits in the recording medium by simultaneous two-photon absorption and reading these recorded record pits, which has a multilayer structure prepared by laminating recording layers and intermediate layers, wherein information is recorded on the recording layers by simultaneous two-photon absorption, the intermediate layers do not change by a recording light, and sensitivities of a part of or all of the recording layers are different.

The simultaneous two-photon three-dimensional optical recording method of the invention is characterized in that simultaneous two-photon absorption is induced on the simultaneous two-photon absorption three-dimensional optical recording medium to three-dimensionally record information.

Further, it is preferred that the sensitivities of a part of or all of the recording layers are increasing from the nearer side to the farther side in the advancing direction of a recording light, and it is preferred that the sensitivities of adjacent two recording layers are the same or the sensitivity of the recording layer on the farther side is higher than the sensitivity of the recording layer on the nearer side in the advancing direction of a recording light.

It is most preferred that the sensitivity of the n^{th} recording layer in the advancing direction of the recording light is higher than the sensitivity of the nearest recording layer in the advancing direction of the recording light by X times or more, wherein X is represented by the following expression (1):

X=[2−(1−Rₛ)(1−Rₜ)ⁿ(1−R_{b})ⁿ⁻¹]/(1+Rₛ+Rₜ−RₛRₜ) (1)

wherein Rₛ represents the reflectance at the surface of the medium and is a real number of 0 or greater and 1 or smaller; Rₜ represents the reflectance at the top face of the recording layer in the advancing direction of a recording light and is a real number of 0 or greater and 1 or smaller; R_{b} represents the reflectance at the bottom face of the recording layer in the advancing direction of a recording light and is a real number of 0 or greater and 1 or smaller; and n is an integer indicating to be the n^{th} recording layer in the advancing direction of the recording light.

That is, the sensitivities of the recording layers in the invention are based on the sensitivity of the recording layer of n=1, and it is most preferred to have sensitivity obtained by multiplying the foregoing value by the value computed according to expression (1) or greater. However, it is not necessary for every recording layer to have sensitivity obtained by multiplying the sensitivity of the recording layer of n=1 by the value computed according to expression (1) or greater, and it is sufficient that the relationship is satisfied as to a certain one layer.

Incidentally, as Rₜ and R_{b}, the values of reflectance at the top face and bottom face of the recording layer of n=1 can be used in every recording layer.

In a multilayer type recording medium, reflection inevitably occurs at the interfaces of the layers, since the refractive index of each layer differs, resulting from the layer structure. Accordingly, the quantity of light for recording lowers on the farther side in the advancing direction of the recording light due to reflection at the interfaces of the layers through which the light has passed as compared with the nearer side, and so the recording sensitivity at the deep part lowers when recording layers having the same sensitivity are used, and high recording light strength is necessary to prevent such a matter. Alternatively, when the light of the same strength is used, recording speed comes to lower. In the invention, reduction of recording sensitivities is prevented by heightening the sensitivities of the recording layers at the deep part more than those on the nearer side in the advancing direction of the recording light according to expression (1).

For increasing the sensitivities of the recording layers at the deep part more than those on the nearer side according to expression (1), the following methods are effective.

(1) To increase the concentration of a two-photon absorption compound in the recording layers at the deep part.

(2) To increase the concentration of a polymerization initiator in the recording layers at the deep part.

(3) To increase the concentration of a polymerizable compound in the recording layers at the deep part.

(4) To increase the concentrations of all of a two-photon absorption compound, a polymerization initiator and a polymerizable compound, or increase the concentrations of combination of any two of these compounds.

The following method is also effective.

(5) To increase the concentration of a dye precursor in the recording layers at the deep part, or increase the concentrations of both two-photon absorption compound and dye precursor.

For increasing the sensitivities at the deep part, any method of the above may be used, and the method can be arbitrarily selected considering the durability of a multilayer recording medium and the storage stability of the matter to be recorded.

It is preferred for the simultaneous two-photon absorption three-dimensional optical recording medium in the invention to contain at least a two-photon absorption compound, a polymerization initiator, a polymerizable compound, and a polymer binder in the recording layers.

It is also preferred for the simultaneous two-photon absorption three-dimensional optical recording medium in the invention to contain at least a two-photon absorption compound, a dye precursor and a polymer binder in the recording layers.

For example, a polymerization initiator generates radical or acid by using excited energy generated by two-photon absorption of a two-photon absorption compound, by which a polymerizable compound is polymerized, and the refractive index can be changed by the change of the structure. It is also possible to change the structure of a dye precursor to change the refractive index by using excited energy generated by two-photon absorption, or change fluorescent strength.

A polymer binder is generally used for the purpose of improving film-forming ability of the composition before polymerization, change of refractive index or change of fluorescent strength, uniformity of a film thickness, and preservation stability. As polymer binders, those having good compatibility with a polymerizable compound, a polymerization initiator, a two-photon absorption compound and a dye precursor are preferably used.

As various kinds of compounds that can be contained in the simultaneous two-photon absorption three-dimensional optical recording medium, for example, the compounds disclosed in JP-A-2007-262155, JP-A-2007-87532, JP-A-2007-59025, JP-A-2007-17887, JP-A-2007-17886, JP-A-2007-17885, JP-A-2006-289613, JP-A-2005-320502, JP-A-2005-164817, JP-A-2005-100606, JP-A-2005-100599, JP-A-2005-92074, JP-A-2005-85350, JP-A-2005-71570, JP-A-2005-55875, JP-A-2005-37658, JP-A-2003-75961, and JP-A-2003-29376 can be exemplified.

### Two-Photon Absorption Compound:

A two-photon absorption compound for use in the invention is a compound capable of non-resonant two-photon absorption (a phenomenon such that a compound is excited by the absorption of two photons simultaneously in the energy region having no linear absorption band of the compound).

Various kinds of compounds that can be used in the simultaneous two-photon absorption three-dimensional optical recording medium of the invention are not especially restricted, and, for example, the compounds disclosed in JP-A-2007-262155, JP-A-2007-87532, JP-A-2007-59025, JP-A-2007-17887, JP-A-2007-17886, JP-A-2007-17885, JP-A-2006-289613, JP-A-2005-320502, JP-A-2005-164817, JP-A-2005-100606, JP-A-2005-100599, JP-A-2005-92074, JP-A-2005-85350, JP-A-2005-71570, JP-A-2005-55875, JP-A-2005-37658, JP-A-2003-75961, and JP-A-2003-29376 can be used.

It is especially preferred that the two-photon absorption compounds for use in the invention are methine dyes. Here, “dye” is a general name to compounds having absorption in visible ray region (400 to 700 nm) or a part of absorption in near infrared ray region (700 to 2,000 nm).

Any methine dye can be used in the invention and, for example, cyanine dyes, hemicyanine dyes, streptocyanine dyes, styryl dyes, merocyanine dyes, trinuclear merocyanine dyes, tetranuclear merocyanine dyes, rhodacyanine dyes, complex cyanine dyes, complex merocyanine dyes, allopolar dyes, oxonol dyes, hemioxonol dyes, squarylium dyes, arylidene dyes, polyene dyes, and the like are exemplified.

The preferred specific examples of the two-photon absorption compounds used in the invention are shown below, but the invention is not restricted to these compounds.

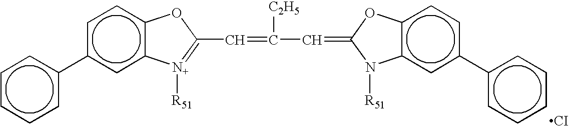

| | R₅₁ | Cl |
|---|---|---|
| D-1 | 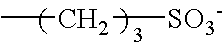 | Na⁺ |
| D-2 | —C₂H₅ | I⁻ |
| D-3 | 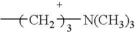 | (Br⁻)₃ |

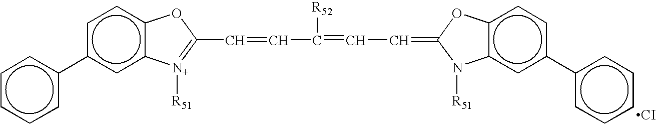

| | R₅₁ | R₅₂ | Cl |
|---|---|---|---|
| D-4 | 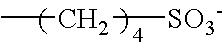 | —H | 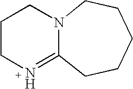 |
| D-5 | —C₂H₅ | ″ | 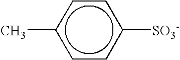 |
| D-6 | 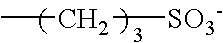 | —C₂H₅ | K⁺ |
| D-7 | 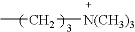 | —CH₃ | (Br⁻)₃ |

| | |
|---|---|
| D-8 | 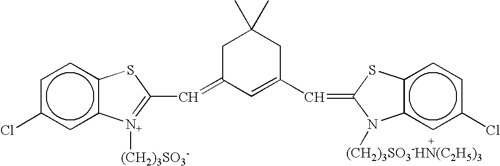 |
| D-9 | 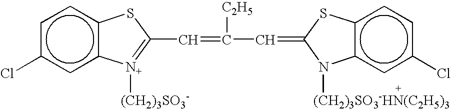 |
| D-10 | 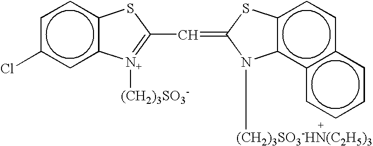 |

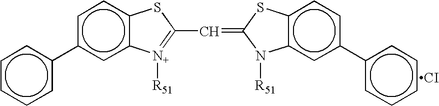

| | R₅₁ | Cl |
|---|---|---|
| D-11 | 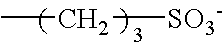 | H⁺N(C₂H₅)₃ |
| D-12 | —C₂H₅ | 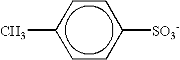 |
| D-13 | 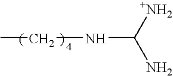 | (Br⁻)₃ |

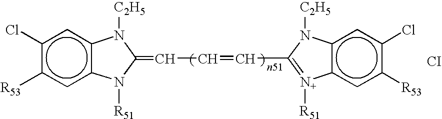

| | R₅₁ | R₅₃ | n₅₁ | Cl |
|---|---|---|---|---|
| D-14 | 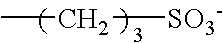 | —Cl | 1 | Na⁺ |
| D-15 | —C₂H₅ | ″ | 1 | I⁻ |
| D-16 | 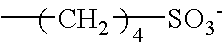 | —CF₃ | ″ | K⁺ |
| D-17 | ″ | —CN | ″ | H⁺N(C₂H₅)₃ |
| D-18 | ″ | —Cl | 2 | 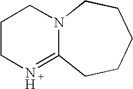 |
| D-19 | 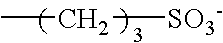 | —CN | ″ | ″ |
| D-20 | —C₂H₅ | ″ | ″ | 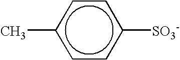 |

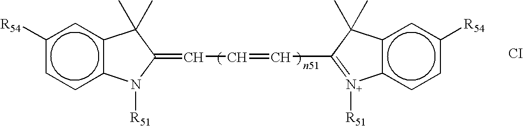

| | R₅₁ | R₅₄ | n₅₁ | Cl |
|---|---|---|---|---|
| D-21 | 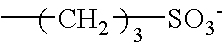 | —H | 1 | 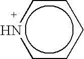 |
| D-22 | —C₄H₉ | —COOH | ″ | 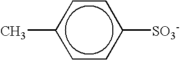 |
| D-23 | —CH₃ | —H | 2 | I⁻ |
| D-24 | 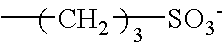 | —COOH | ″ | Na⁺ |
| D-25 | 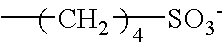 | —H | 3 | K⁺ |
| D-26 | 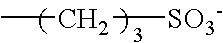 | —COOH | ″ | ″ |
| D-27 | —CH₃ | —CONH₂ | ″ | 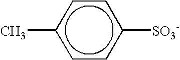 |

| | |
|---|---|
| D-28 | 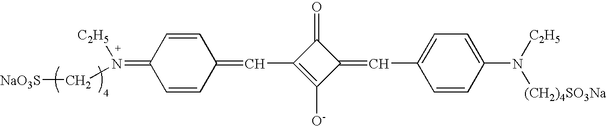 |
| D-29 | 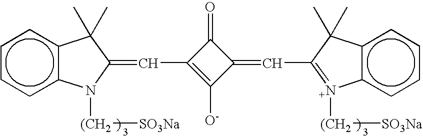 |

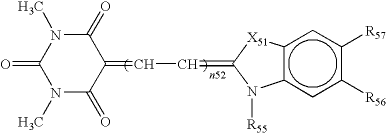

| | R₅₅ | R₅₆ | R₅₇ | X₅₁ | n₅₂ |
|---|---|---|---|---|---|
| D-30 | 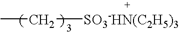 | —Cl | —H | —O— | 1 |
| D-31 | —C₂H₅ | —H | —COOH | ″ | 2 |
| D-32 | 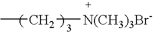 | 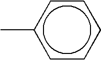 | —H | ″ | ″ |
| D-33 | 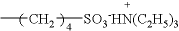 | —CH₃ | —CH₃ | —S— | ″ |
| D-34 | 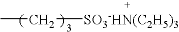 | —H | —H | —C(CH₃)₂— | ″ |
| D-35 | —CH₃ | ″ | ″ | ″ | ″ |
| D-36 | 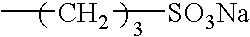 | ″ | —COOH | ″ | ″ |
| D-37 | —CH₃ | ″ | —CONH₂ | ″ | ″ |
| D-38 | 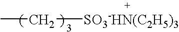 | ″ | —H | ″ | 3 |

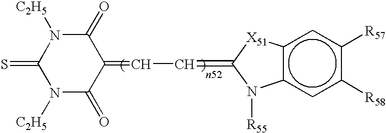

| | R₅₅ | R₅₆ | R₅₇ | X₅₁ | n₅₂ |
|---|---|---|---|---|---|
| D-39 | 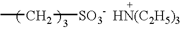 | —Cl | —H | —S— | 1 |
| D-40 | —C₂H₅ | —H | —CONH₂ | —O— | 2 |
| D-41 | 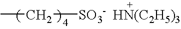 | —CH₃ | —CH₃ | —S— | ″ |
| D-42 | 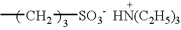 | —H | —H | —C(CH₃)₂— | ″ |
| D-43 | 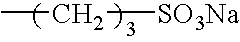 | ″ | —COOH | ″ | ″ |
| D-44 | —CH₃ | ″ | —CONH₂ | ″ | ″ |
| D-45 | ″ | ″ | ″ | ″ | 3 |

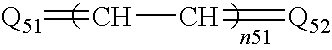

| | Q₅₁ | Q₅₂ | n₅₁ |
|---|---|---|---|
| D-46 | 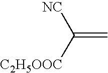 | 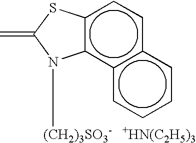 | 2 |
| D-47 | 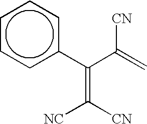 | 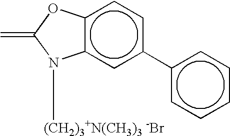 | 1 |
| D-48 | 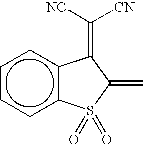 | 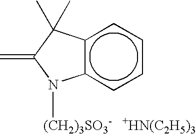 | 1 |
| D-49 | 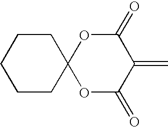 | 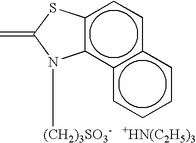 | 2 |
| D-50 | 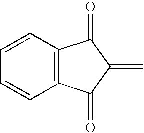 | 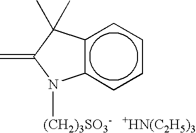 | 2 |
| D-51 | 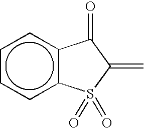 | ″ | 2 |
| D-52 | 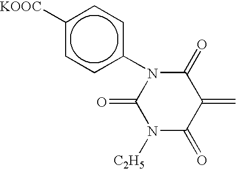 | 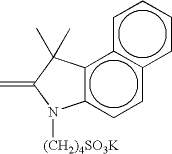 | 3 |
| D-53 | 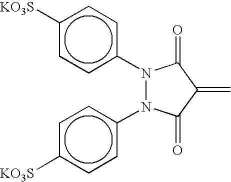 | 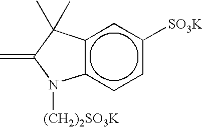 | 3 |
| D-54 | 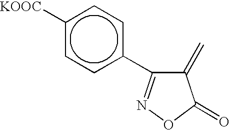 | 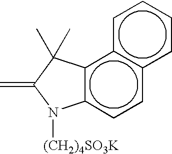 | 3 |
| D-55 | 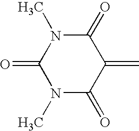 | 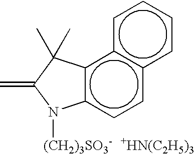 | 2 |

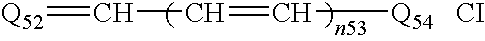

| | Q₅₃ | Q₅₄ | n₅₃ | CI |
|---|---|---|---|---|
| D-56 | 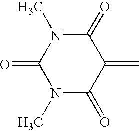 | 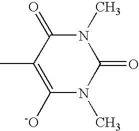 | 2 | H⁺ |
| D-57 | 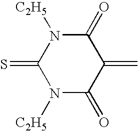 | 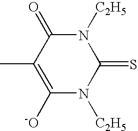 | 1 | 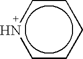 |
| D-58 | ″ | ″ | 2 | 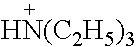 |
| D-59 | 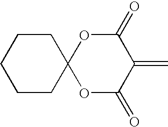 | 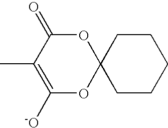 | 2 | H⁺ |
| D-60 | 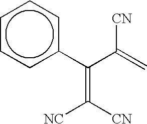 | 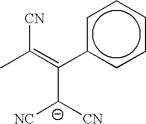 | 1 | 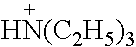 |
| D-61 | 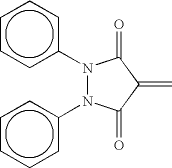 | 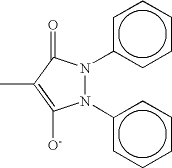 | 2 | H⁺ |
| D-62 | 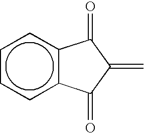 | 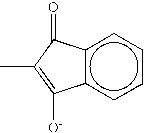 | 2 | 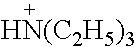 |
| D-63 | 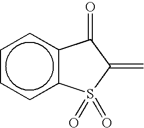 | 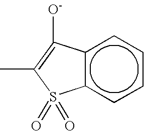 | 2 | ″ |
| D-64 | 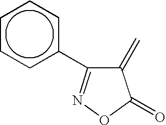 | 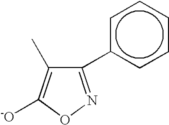 | 2 | H⁺ |

| | |
|---|---|
| D-65 | 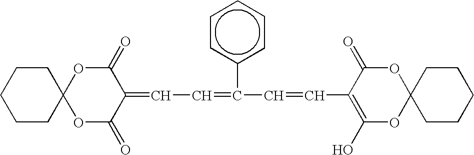 |
| D-66 | 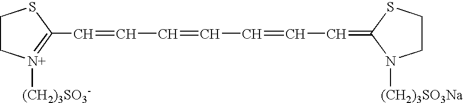 |
| D-67 | 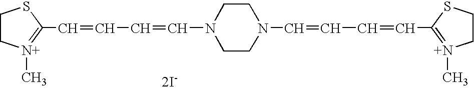 |
| D-68 | 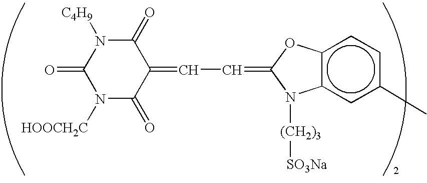 |
| D-69 | 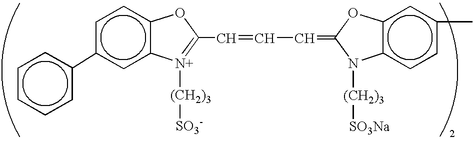 |
| D-70 | 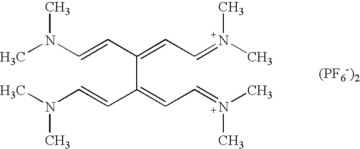 |
| D-71 | 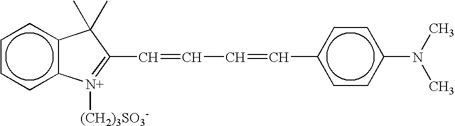 |
| D-72 | 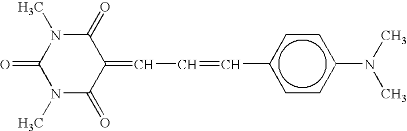 |

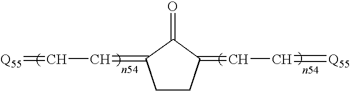

| | Q₅₅ | n₅₄ |
|---|---|---|
| D-73 | 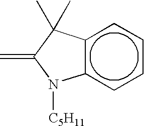 | 2 |
| D-74 | 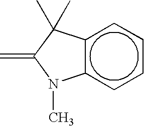 | 1 |
| D-75 | 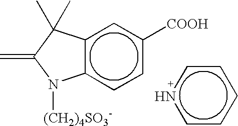 | 1 |
| D-76 | 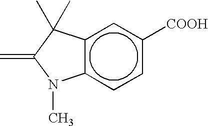 | 2 |
| D-77 | 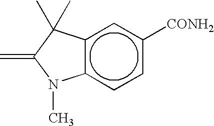 | 2 |
| D-78 | 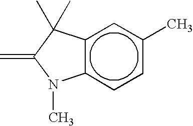 | 2 |
| D-79 | 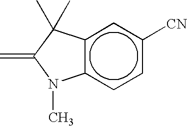 | 2 |
| D-80 | 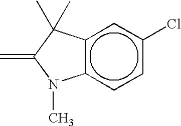 | 2 |
| D-81 | 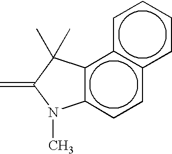 | 2 |
| D-82 | 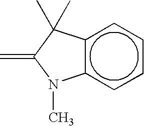 | 2 |

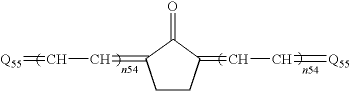

| | Q₅₅ | n₅₄ |
|---|---|---|
| D-83 | 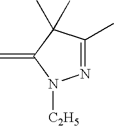 | 2 |
| D-84 | 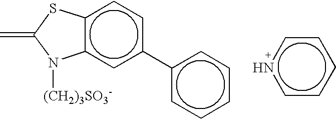 | 1 |
| D-85 | 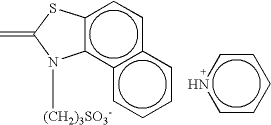 | 1 |
| D-86 | 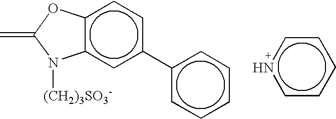 | 1 |
| D-87 | 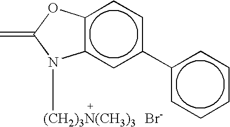 | 1 |
| D-88 | 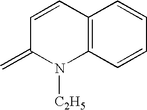 | 1 |
| D-89 | 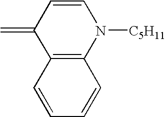 | 1 |

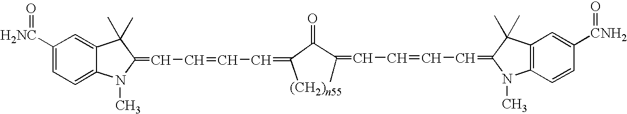

| | n₅₅ |
|---|---|
| D-90 | 0 |
| D-91 | 1 |
| D-92 | 3 |

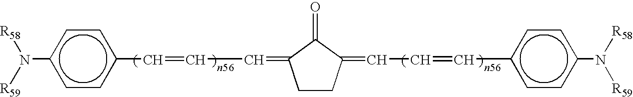

| | R₅₈ | R₅₉ | n₅₆ |
|---|---|---|---|
| D-93 | —C₂H₅ | —C₂H₅ | 0 |
| D-94 | —CH₃ | —CH₃ | 1 |
| D-95 | ″ | 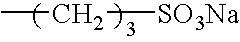 | 4 |
| D-96 | ″ | —CH₃ | 2 |
| D-97 | ″ | —COOH | ″ |
| D-98 | ″ | —CH₃ | 3 |
| D-99 | 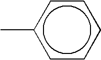 | 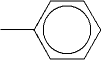 | 2 |

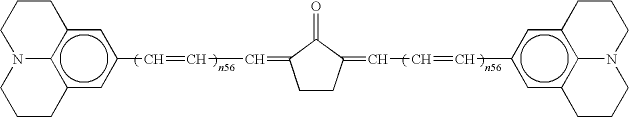

| | n₅₆ |
|---|---|
| D-100 | 1 |
| D-101 | 2 |
| D-102 | 3 |

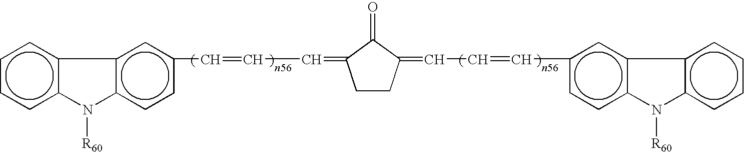

| | R₆₀ | n₅₆ |
|---|---|---|
| D-103 | —C₂H₅ | 0 |
| D-104 | ″ | 1 |
| D-105 | ″ | 2 |
| D-106 | —CH₂COOH | ″ |
| D-107 | 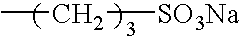 | ″ |

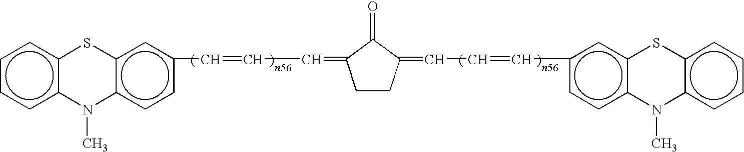

| | n₅₆ |
|---|---|
| D-108 | 1 |
| D-109 | 2 |

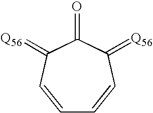

| | Q₅₆ |
|---|---|
| D-110 | 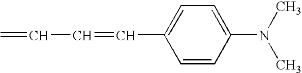 |
| D-111 | 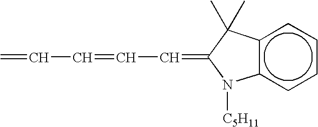 |

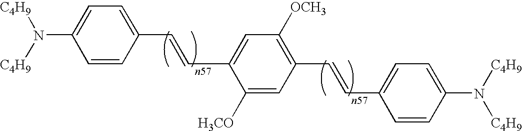

| | n₅₇ |
|---|---|
| D-112 | 1 |
| D-113 | 2 |

| | |
|---|---|
| D-114 | 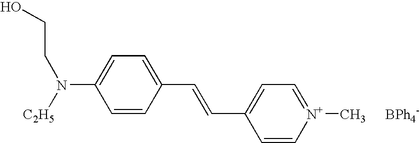 |
| D-115 | 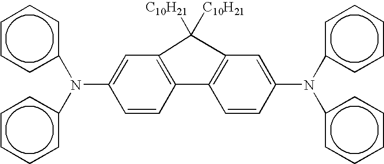 |
| D-116 | 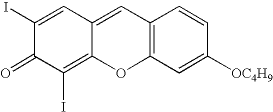 |
| D-117 | 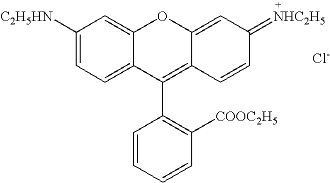 |
| D-118 | 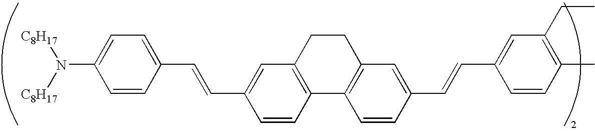 |

| | |
|---|---|
| 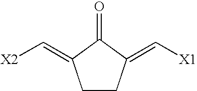 | $\frac{2}{p} {Y}^{{P}^{⊖}}$ |

| Compound No. | X1 | X2 | $\frac{2}{p} {Y}^{{P}^{⊖}}$ |
|---|---|---|---|
| D-119 | 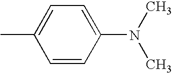 | 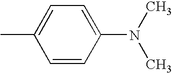 | — |
| D-120 | 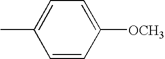 | 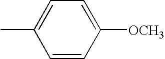 | — |
| D-121 | 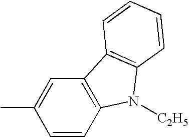 | 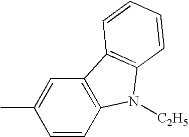 | — |
| D-122 | 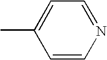 | 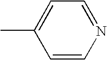 | — |
| D-123 | 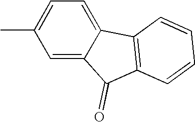 | 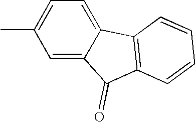 | — |
| D-124 | 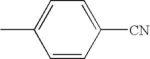 | 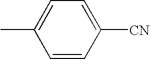 | — |
| D-125 | 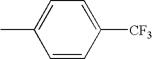 | 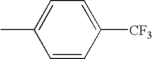 | — |
| D-126 | 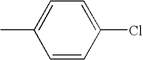 | 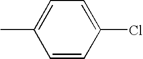 | — |
| D-127 | 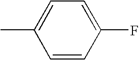 | 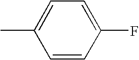 | — |
| D-128 | 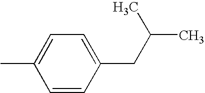 | 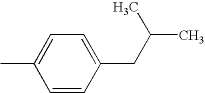 | — |
| D-129 | 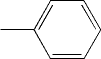 | 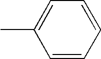 | — |
| D-130 | 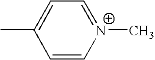 | 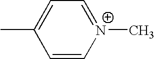 | ClO₄^{⊖} |
| D-131 | 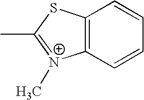 | 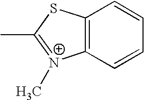 | PF₆^{⊖} |
| D-132 | 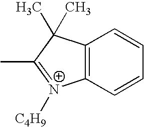 | 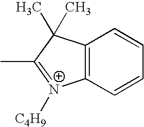 | 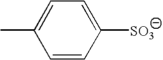 |

The above-exemplified compounds can be manufactured by ordinary methods. For example, the method disclosed in JP-A-2003-75961, JP-A-2003-183213, JP-A-2004-123668, JP-A-2004-126440, JP-A-2004-149517 and JP-A-2004-224864 can be used. Some compounds are commercially available.

When non-resonant two-photon absorption recording is performed by using recording lights especially in the region of wavelengths shorter than 700 nm, a compound having the structure represented by formula (1) shown below is preferably used as a two-photon absorption compound for use in the simultaneous two-photon absorption three-dimensional optical recording medium of the invention.

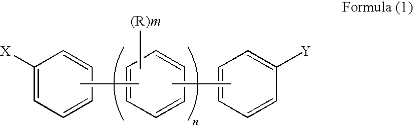

In formula (1), X and Y, which may be the same or different, each represents a substituent having Hammett's sigma para value (σp value) of 0 or more; n represents an integer of 1 to 4; R represents a substituent, and each R may be the same with or different from every other R; and m represents an integer of 0 to 4.

In formula (1), each of X and Y represents a group having Hammett's σp value of a positive value, i.e., what is called an electron-withdrawing group, preferably a trifluoromethyl group, a heterocyclic group, a halogen atom, a cyano group, a nitro group, an alkylsulfonyl group, an arylsulfonyl group, a sulfamoyl group, a carbamoyl group, an acyl group, an acyloxy group, and an alkoxycarbonyl group are exemplified, more preferably a trifluoromethyl group, a cyano group, an acyl group, an acyloxy group, and an alkoxycarbonyl group, and most preferably a cyano group and a benzoyl group. Of these substituents, an alkylsulfonyl group, an arylsulfonyl group, a sulfamoyl group, a carbamoyl group, an acyl group, an acyloxy group, and an alkoxycarbonyl group may further have a substituent for giving solubility in a solvent, and other various purposes. As further substituents, an alkyl group, an alkoxy group, an alkoxyalkyl group and an aryloxy group are exemplified.

n represents an integer of 1 to 4, more preferably 2 or 3, and most preferably 2. The more n is 5 or more, the more linear absorption occurs on long wavelength side, and non-resonant two-photon absorption recording cannot be done with a recording light in the region of the wavelength of 700 nm or shorter.

R represents a substituent, and the substituent is not especially restricted. Specifically, an alkyl group, an alkoxy group, an alkoxyalkyl group, and an aryloxy group are exemplified. m represents an integer of 0 to 4.

In the compound having the structure represented by formula (1), the effect that each of X and Y preferably represents a group having Hammett's σp value of a positive value, i.e., what is called an electron-withdrawing group is described below.

According to T. Kogej, et al., Chem. Phys. Lett., 298, 1 (1998), two-photon absorption efficiency of an organic compound, that is, two-photon absorption cross sectional area δ is in the following relationship with the imaginary number portion of third molecular polarizability (second hyper-polarizability) γ.

$$δ ( ω ) = ( \frac{3 π {hv}^{2}}{{n}^{2} {c}^{2} {ɛ}_{0}} ) Im v ( - ω ; ω , - ω , ω ) \qquad Equation ( 1 )$$

In equation (1), c represents speed of light; ν represents a frequency; n represents a refractive index; ε₀ represents a dielectric constant in a vacuum; ω represents the number of vibration of a photon; and Im represents an imaginary number portion. The imaginary number portion of γ (Imγ) is in the following relationship with dipole moment between |g> and |e>: Mge, dipole moment between |g> and |e′>: Mge′, the difference between dipole moment of |g> and |e>: Δμge, transition energy: Ege, and damping factor: Γ.

$$Im v ( - ω ; ω , - ω , ω ) = Im P [ \begin{matrix}\frac{{Mge}^{2} Δμ {ge}^{2}}{\begin{matrix}\begin{matrix}( Ege - ℏω - iΓ ge ) \\ ( Ege - 2 ℏω - iΓ ge )\end{matrix} \\ ( Ege - ℏω - iΓ ge )\end{matrix}} + \\ {\sum }_{{e}^{′}} \frac{{Mge}^{2} {Mee}^{′2}}{\begin{matrix}\begin{matrix}( Ege - ℏω - iΓ ge ) \\ ( {Ege}^{′} - 2 ℏω - iΓ {ge}^{′} )\end{matrix} \\ ( Ege - ℏω - iΓ ge )\end{matrix}} - \\ \frac{{Mge}^{4}}{\begin{matrix}( Ege - ℏω - iΓ ge ) \\ ( Ege + ℏω + iΓ ge )\end{matrix}} \\ ( Ege - ℏω - iΓ ge )\end{matrix} ] \qquad Equation ( 2 )$$

In equation (2), P represents a variable operator.

Accordingly, it is possible to estimate the two-photon absorption cross sectional area of a compound by the computation of the value of equation (2). Accordingly, by performing computation according to DPT method using B3LYP functional with the most stable structure 6-31G* of normal state as the base function, and by computing Mge, Mee′ and Ege on the basis of the results, the value of Imγ can be calculated. For example, in a compound having the structure represented by formula (1), when the maximum value of Imγ obtained from computation of a quaterphenyl compound of X and Y substituted with an electron donating substituent methoxy group is taken as 1, as other substituents, the relative value of the maximum value of Imγ of the molecule having Hammett's σp value of a positive value, i.e., what is called an electron-withdrawing group, becomes great.

In a compound having the structure represented by formula (1), in a quaterphenyl compound of X and Y substituted with an electron donating methoxy group, Imγ is small, and in the molecules of X and Y both substituted with an electron-withdrawing substituent, Imγ generally largely increases. As described above, since two-photon absorption cross sectional area δ is theoretically in proportion to the imaginary number portion of third hyper-polarizability γ, that is, Imγ, it is preferred from these computations for both X and Y to have a structure substituted with an electron-withdrawing group.

The compound having the structure represented by formula (1) is preferably a compound having a structure represented by the following formula (2).

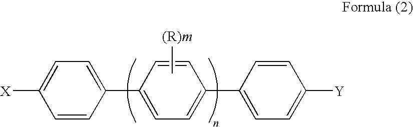

In formula (2), each of X, Y, n, R and m has the same meaning as in formula (1).

In the compound having the structure represented by formula (1) or (2), X and Y may be the same with or different from each other, but preferably X and Y are different for the reason that a two-photon absorption cross sectional area is liable to be large when they are different.

The specific examples of the compound having the structure represented by formula (1) or (2) are not especially restricted but the following compounds are exemplified.

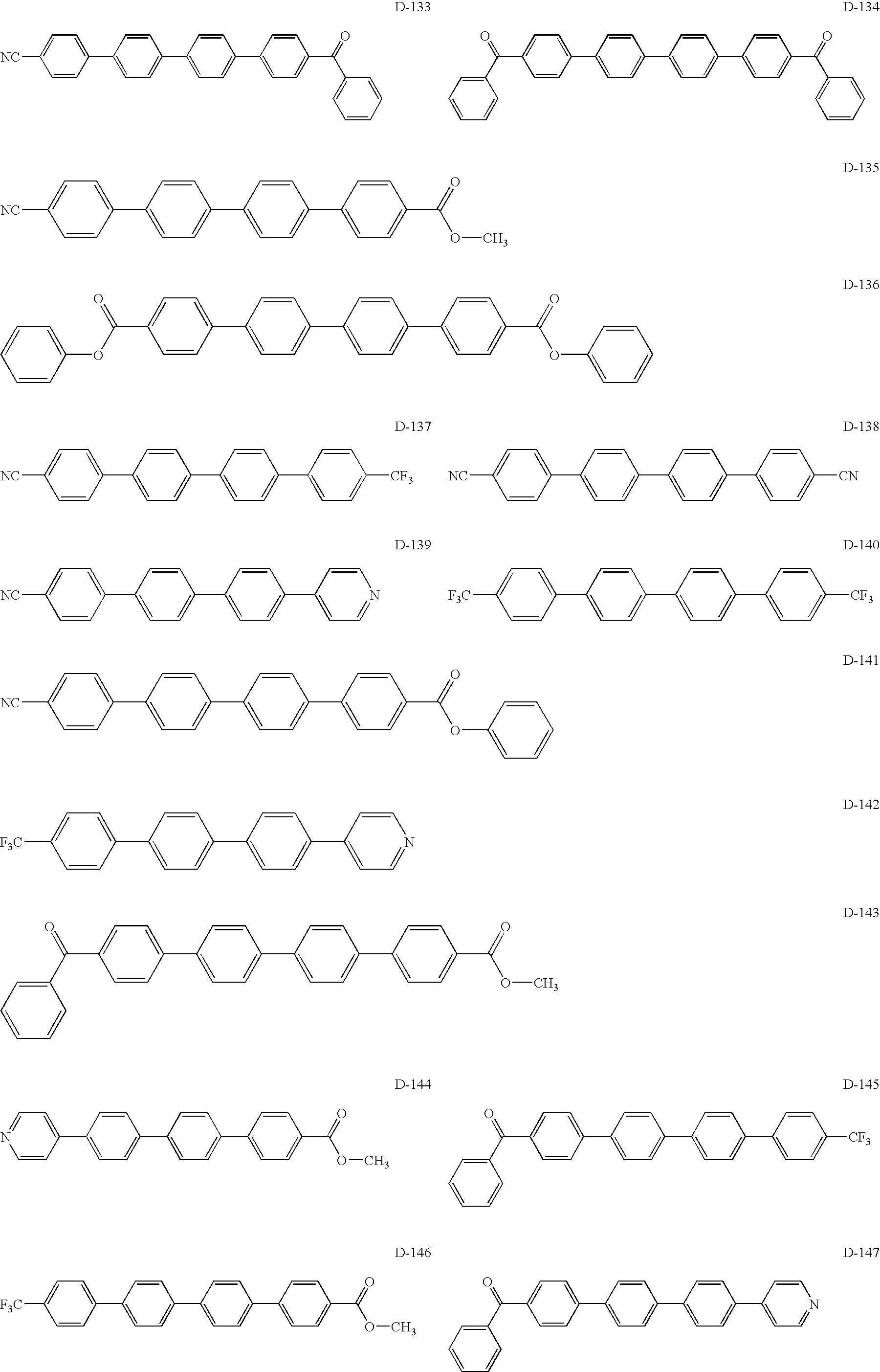

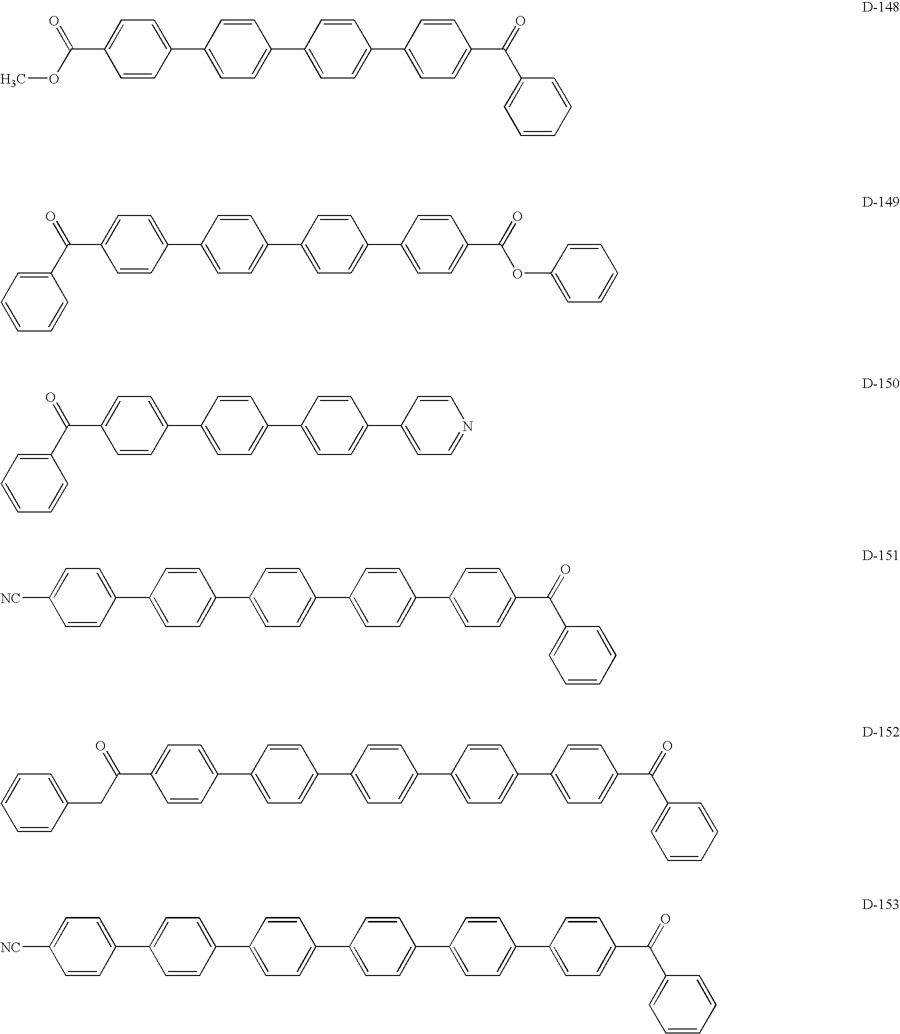

Of the above compounds, the compound D-133 is preferred.

The content of the two-photon absorption compound is preferably 0.01 to 10 mass % based on the recording layer, and more preferably 0.1 to 7 mass %.

### Polymerization Initiator:

As the polymerization initiators that can be used in the two-photon absorption three-dimensional recording medium in the invention, the polymerization initiators disclosed in JP-A-2004-346238, JP-A-2005-97538, JP-A-2005-99416, JP-A-2004-292475, and JP-A-2004-292476 are exemplified.

The polymerization initiators that can be used in the two-photon absorption three-dimensional recording medium in the invention are preferably bisimidazole polymerization initiators. The preferred bisimidazole-based polymerization initiators are bis(2,4,5-triphenyl)imidazole derivatives, e.g., bis(2,4,5-triphenyl)imidazole, a 2-(o-chlorophenyl)-4,5-bis(m-methoxyphenyl)-imidazole dimer (CDM-HABI), 1,1′-biimidazole, 2,2′-bis(o-chlorophenyl)-4,4′,5,5′-tetraphenyl(o-Cl-HABI), 1H-imidazole, and 2,5-bis(o-chlorophenyl)-4-(3,4-dimethoxyphenyl)-dimer-(TCTM-HABI) are exemplified.

It is preferred that bisimidazole polymerization initiators are used together with a hydrogen donor. As preferred hydrogen donors, 2-mercaptobenzoxazole, 2-mercaptobenzothiazole, and 4-methyl-4H-1,2,4-triazole-3-thiol are exemplified.

As the polymerization initiators for use in the two-photon absorption three-dimensional recording medium of the invention, diaryl iodonium polymerization initiator can also be preferably used. The diaryl iodonium polymerization initiator is preferably represented by the following formula (3):

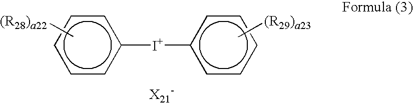

In formula (3), X₂₁⁻ is an anion such that HX₂₁ becomes an acid having a pKa of 4 or less (in water, at 25° C.), preferably 3 or less, more preferably 2 or less, and preferred examples thereof include chloride, bromide, iodide, tetrafluoroborate, hexafluorophosphate, hexafluoroarcenate, hexafluoroantimonate, perchlorate, trifluoromethanesulfonate, 9,10-dimethoxyanthracene-2-sulfonate, methanesulforate, benzenesulfonate, 4-trifluoromethylbenzenesulfonate, and tosylate.

Each of R₂₈ and R₂₉ independently represents a substituent, preferably an alkyl group, an alkoxy group, a halogen atom, a cyano group or a nitro group.

Each of a22 and a23 independently represents an integer of 0 to 5, and preferably an integer of 0 or 1. When a22 and a23 represent 2 or more, a plurality of R₂₈ and R₂₉ may be the same or different, and they may be bonded to each other to form a ring.

The specific examples of the diaryl iodonium polymerization initiators include chloride, bromide, iodide, e.g., diphenyl iodonium, 4,4′-dichlorodiphenyl iodonium, 4,4′-dimethoxydiphenyl iodonium, 4,4′-dimethyldiphenyl iodonium, 4,4′-t-butylphenyl iodonium, 3,3′-dinitrodiphenyl iodonium, phenyl(p-methoxyphenyl) iodonium, bis(p-cyanophenyl) iodonium, tetrafluoroborate, hexafluorophosphate, hexafluoroarsenate, hexafluoroantimonate, perchlorate, trifluoromethanesulfonate, 9,10-dimethoxyanthracene-2-sulfonate, methanesulfonate, benzenesulfonate, 4-trifluoromethylbenzenesulfonate, and tosylate.

Further, the diaryl iodonium salts as described in Macromolecules, Vol. 10, p. 1307 (1977), JP-A-58-29803, JP-A-1-287105, and Japanese Patent Application No. 3-5569 are also exemplified.

As the polymerization initiators for use in the two-photon absorption three-dimensional recording medium of the invention, sulfonium salt polymerization initiators can also be preferably used. The sulfonium salt polymerization initiator is preferably represented by the following formula (4):

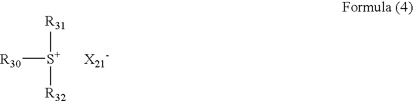

In formula (4), X₂₁⁻ has the same meaning as in formula (3). Each of R₃₀, R₃₁ and R₃₂ independently represents an alkyl group, an aryl group or a heterocyclic group (preferred examples are the same as the substituents on Za₁), and preferably represents an alkyl group, a phenacyl group or an aryl group.

As the specific examples of the sulfonium salt polymerization initiators, chloride, bromide, e.g., triphenyl sulfonium, diphenylphenacyl sulfonium, dimethylphenacyl sulfonium, benzyl-4-hydroxyphenylmethyl sulfonium, 4-t-butyltriphenyl sulfonium, tris(4-methylhenyl) sulfonium, tris(4-methoxyphenyl) sulfonium, 4-thiophenyltriphenyl sulfonium, tetrafluoroborate, hexafluorophosphate, hexafluoroarsenate, hexafluoroantimonate, perchlorate, trifluoromethanesulfonate, 9,10-dimethoxyanthracene-2-sulfonate, methanesulfonate, benzenesulfonate, 4-trifluoromethylbenzenesulfonate, and tosylate are exemplified.

The content of the polymerization initiators is preferably 0.01 to 10 mass % based on the recording layer, and more preferably 0.1 to 7 mass %.

### Polymerizable Compound:

Polymerizable compounds that can be used in the two-photon absorption three-dimensional recording medium in the invention are described below.

Polymerizable compounds are roughly classified into the polymerizable compound capable of radical polymerization and the polymerizable compound capable of cationic polymerization.

As the radical polymerizable compounds, compounds having at least one ethylenically unsaturated double bond in the molecule are preferred.

The cation polymerizable compounds for use in the invention are compounds whose polymerization is started by acid generated by a two-photon absorption compound and a cationic polymerization initiator, and the compounds described, e.g., in J. V. Crivello, Chemtech. Oct., p. 624 (1980), JP-A-62-149784, and Nippon Setchaku Gakkai-Shi (Bulletin of the Adhesion Society of Japan), Vol. 26, No. 5, pp. 179-187 (1990) are exemplified.

The cation polymerizable compounds preferably used in the invention are compounds having at least one oxirane ring, oxetane ring, or vinyl ether group site in the molecule, and more preferably compounds having an oxirane ring site.

Specifically, the following cation polymerizable monomers and prepolymers (e.g., dimers, oligomers, etc.) comprising thereof are exemplified.

The details of the polymerizable compounds that can be used in the invention are disclosed in JP-A-2004-292475, JP-A-2004-292476, JP-A-2004-346238, JP-A-2005-23126, JP-A-5-27436 and JP-A-6-43634.

The use amount of the polymerizable compounds is preferably 5 to 60 mass % based on the recording layer, and more preferably 15 to 50 mass %.

### Polymer Binder:

The recording layer of the simultaneous two-photon absorption three-dimensional recording medium of the invention may contain a polymer binder.

Monomers concerning recording and storage and polymer compounds for retaining photopolymerization initiators are contained in the polymer binder. As the polymer binders for use in the invention, polyacrylate and polymethacrylate derivatives, polyvinyl acetate, polyvinyl alcohol, polystyrene derivatives, and copolymers of these compounds are preferably used.

The details of the polymer binders that can be used in the invention are disclosed in JP-A-2007-262155, JP-A-2007-87532, JP-A-2007-59025, JP-A-2007-17887, JP-A-2007-17886, JP-A-2007-17885, JP-A-2006-289613, JP-A-2005-320502, JP-A-2005-164817, JP-A-2005-100606, JP-A-2005-100599, JP-A-2005-92074, JP-A-2005-85350, JP-A-2005-71570, JP-A-2005-55875, JP-A-2005-37658, JP-A-2003-75961, JP-A-2003-29376, JP-A-5-27436, and JP-A-6-43634.

The use amount of the polymer binders is preferably 0 to 90 mass % based on the recording layer in the case of a recording material utilizing the polymerization of a polymerizable compound, and more preferably 45 to 75 mass %. Further, in the case of a recording material of the type varying the refractive index and fluorescent strength by developing a dye precursor, the use amount is preferably 50 to 99.5 mass % based on the recording layer, and more preferably 70 to 99 mass %.

### Dye Precursor:

Dye precursors usable in the invention are not especially restricted, and dye precursors capable of developing colors by oxidation reaction can be exemplified.

Dye precursors capable of developing colors by oxidation reaction are not especially restricted so long as they are compounds increasing extinction by oxidation reaction, and it is preferred to contain at least any one compound of leuco quinone compounds, thiazine leuco compounds, oxazine leuco compounds, phenazine leuco compounds and leuco triarylmethane compounds.

Thiazine leuco compounds, oxazine leuco compounds, and phenazine leuco compounds as the dye precursors capable of developing colors by oxidation reaction are preferably compounds having a partial structure represented by the following formula (5) or (6).

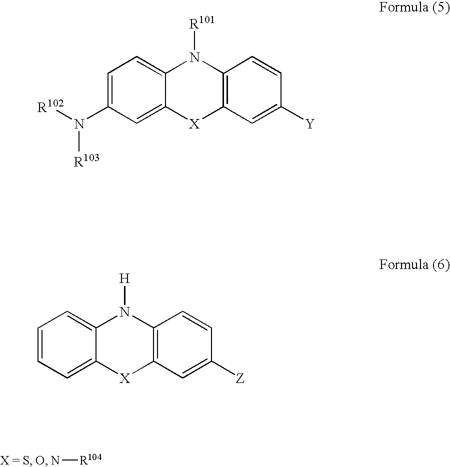

In the above formulae, X represents a sulfur atom, an oxygen atom, or a substituted nitrogen atom; each of R¹⁰¹, R¹⁰², R¹⁰³ and R¹⁰⁴ represents a hydrogen atom or a substituent; and each of Y and Z represents a substituent.

R¹⁰¹ in formula (5) preferably represents an arylcarbonyl group, an alkylcarbonyl group, an alkoxycarbonyl group, an alkylsulfonyl group, an arylsulfonyl group or an alkylaminocarboxy group, more preferably an arylcarbonyl group, an alkylcarbonyl group, or an alkoxycarbonyl group, and especially preferably a benzoyl group, an acyl group or a t-butoxycarbonyl group. R¹⁰¹ in formula (5) may further have a substituent.

Each of R¹⁰² and R¹⁰³ in formula (5) preferably represents a hydrogen atom, an alkyl group or aryl group having 1 to 20 carbon atoms, an alkylcarbonylamino group, or an arylcarbonylamino group, more preferably an alkyl group or aryl group having 1 to 10 carbon atoms, and most preferably an alkyl group having 1 to 8 carbon atoms. R¹⁰² and R¹⁰³ in formula (5) may further have a substituent.

R¹⁰⁴ in formula (5) preferably represents an alkyl group or aryl group having 1 to 20 carbon atoms, more preferably an alkyl group or aryl group having 1 to 10 carbon atoms, and most preferably an alkyl group or a phenyl group having 1 to 8 carbon atoms. R¹⁰⁴ in formula (5) may further have a substituent.

Y in formula (5) preferably represents a hydroxyl group, an amino group, an alkylamino group, a dialkylamino group, an alkylcarbonylamino group, an arylcarbonylamino group, an arylcarboxy group, an alkylcarboxy group, or a di-substituted methyl group, and more preferably a dialkylamino group, an alkylcarbonylamino group, or an arylcarbonylamino group.

Y in formula (5) may further have a substituent.

Z in formula (6) preferably represents an amino group, an alkylamino group, a dialkylamino group, an alkylcarbonylamino group, an arylcarbonylamino group, an arylcarboxy group, an alkylcarboxy group, or a di-substituted methyl group, and more preferably an arylcarbonylamino group, or a di-substituted methyl group, and most preferably a phenylamino group, or a dicyanomethyl group. Z in formula (6) may further have a substituent.

The specific examples of the thiazine leuco compounds, oxazine leuco compounds, and phenazine leuco compounds are shown below, but the invention is not limited thereto.

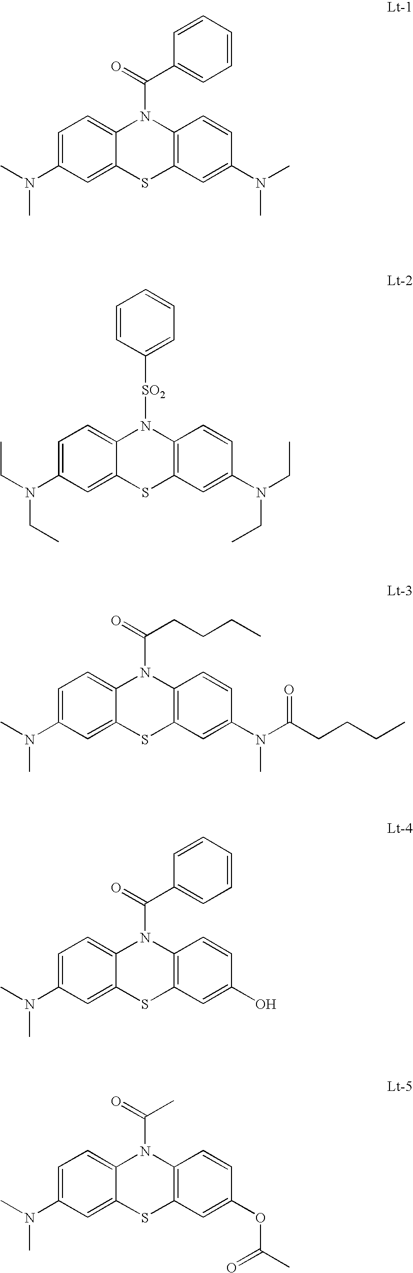

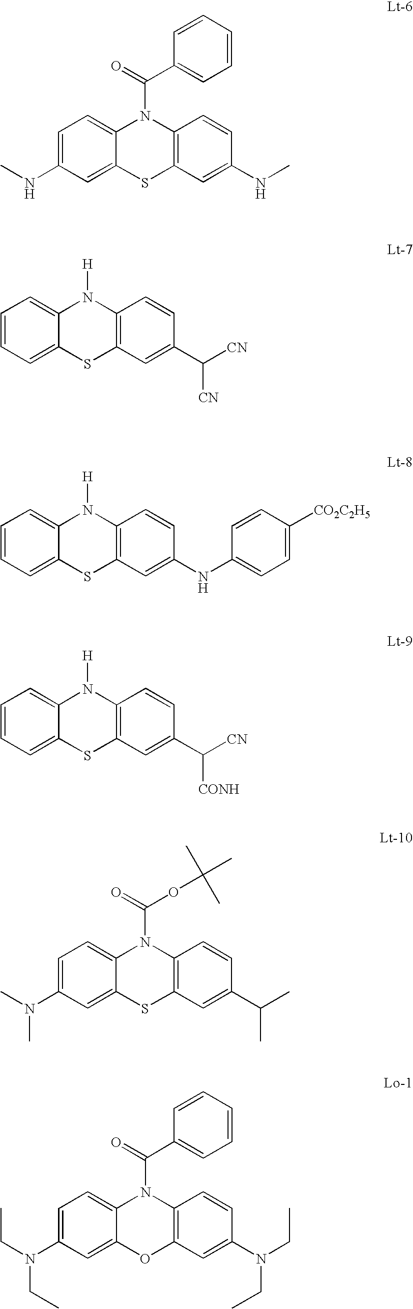

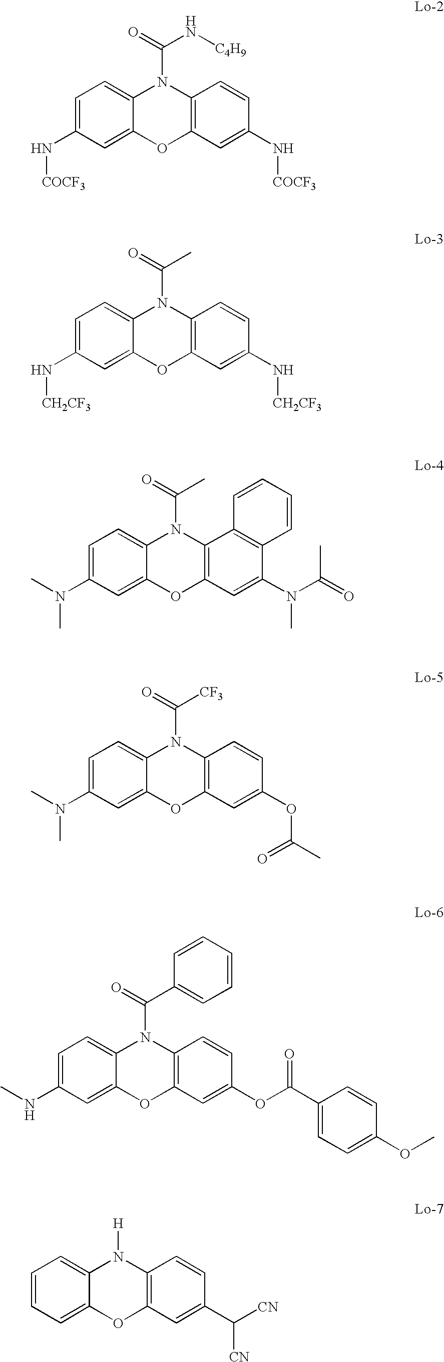

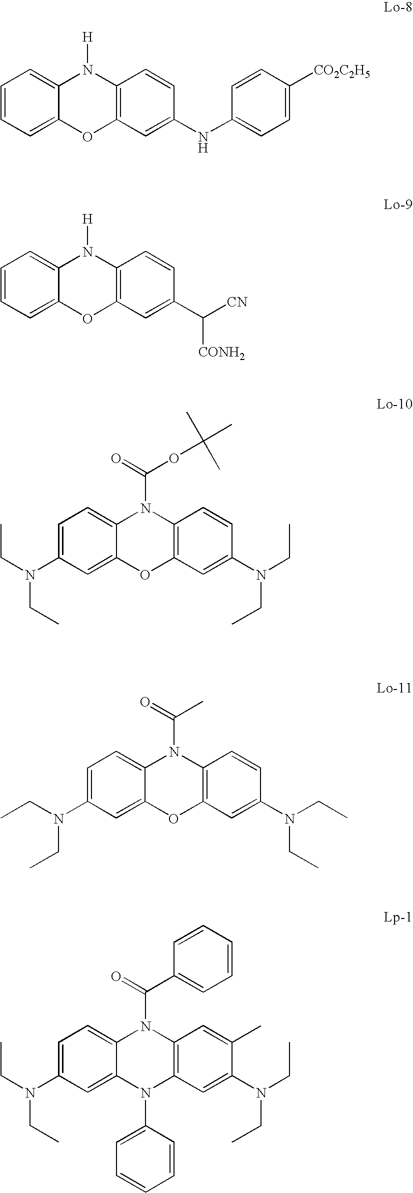

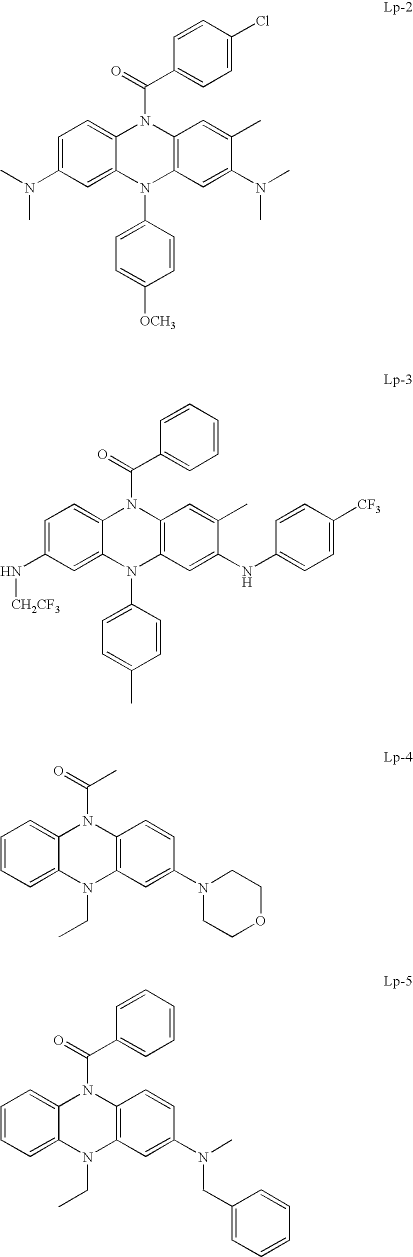

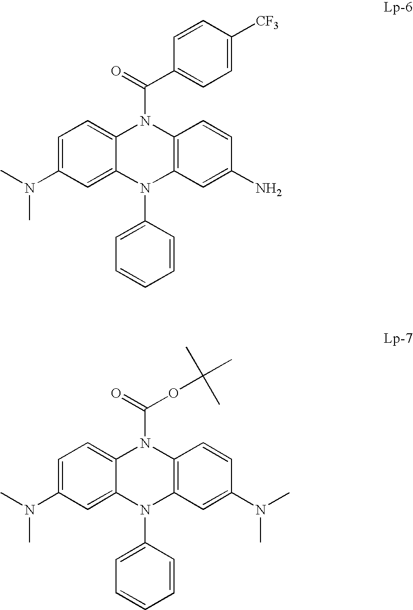

As the dye precursors capable of developing colors by oxidation reaction, leuco triarylmethane compounds having a partial structure represented by the following formula (7) are also more preferably used.

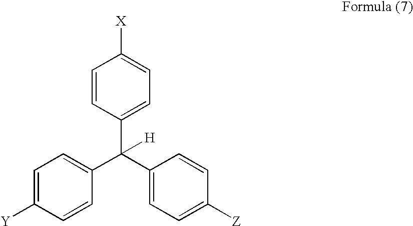

In formula (7), X represents a hydrogen atom, an amino group, an alkylamino group, a dialkylamino group, an arylamino group, a diarylamino group, or a hydroxy group; and each of Y and Z independently represents an amino group, an alkylamino group, a dialkylamino group, an arylamino group, a diarylamino group, or a hydroxy group. X in formula (7) preferably represents a hydrogen atom, an alkylamino group, a dialkylamino group, or a diarylamino group, and more preferably a dialkylamino group or a diarylamino group. Each of Y and Z in formula (7) preferably represents an alkylamino group, a dialkylamino group, or a diarylamino group, and more preferably a dialkylamino group or a diarylamino group.

Each of X, Y and Z in formula (7) may further have a substituent.

In formula (7), the carbon atoms of the phenyl group may substitute on a substituent exclusive of bonding hydrogen atom.

The specific examples of the leuco triarylmethane compounds are shown below, but the invention is not restricted thereto.

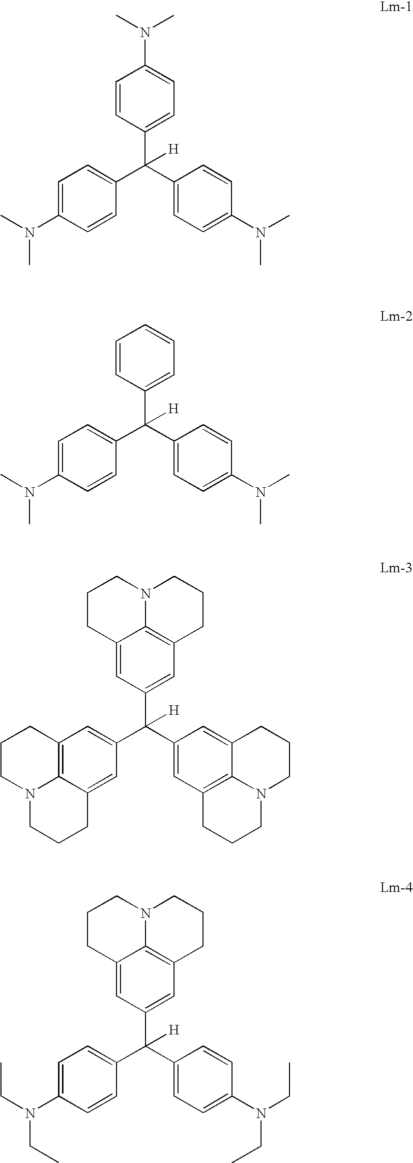

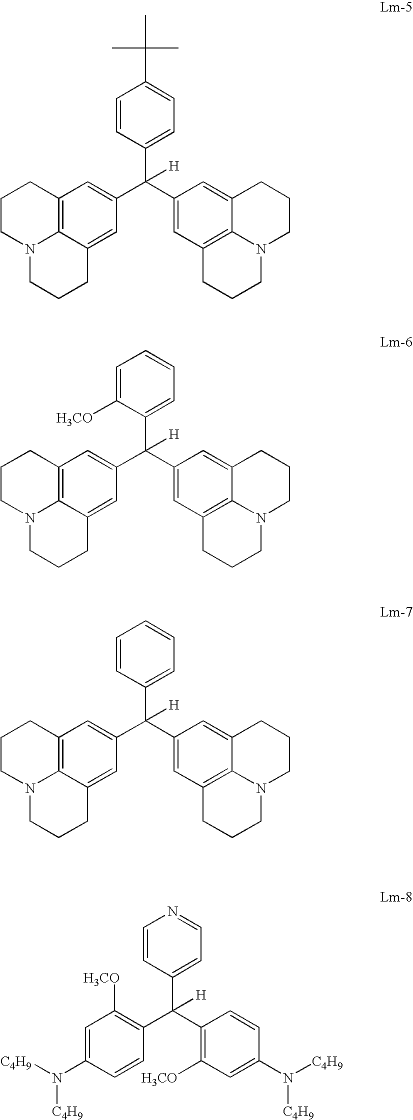

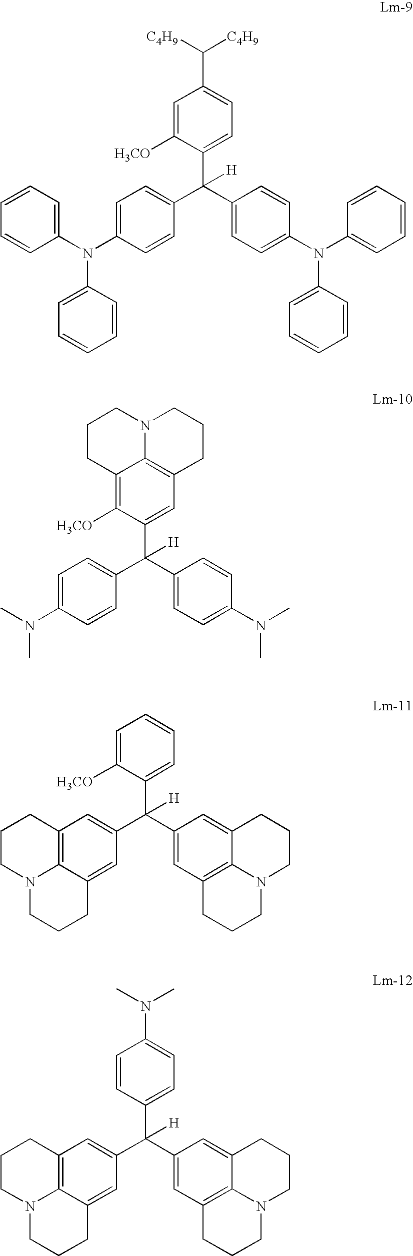

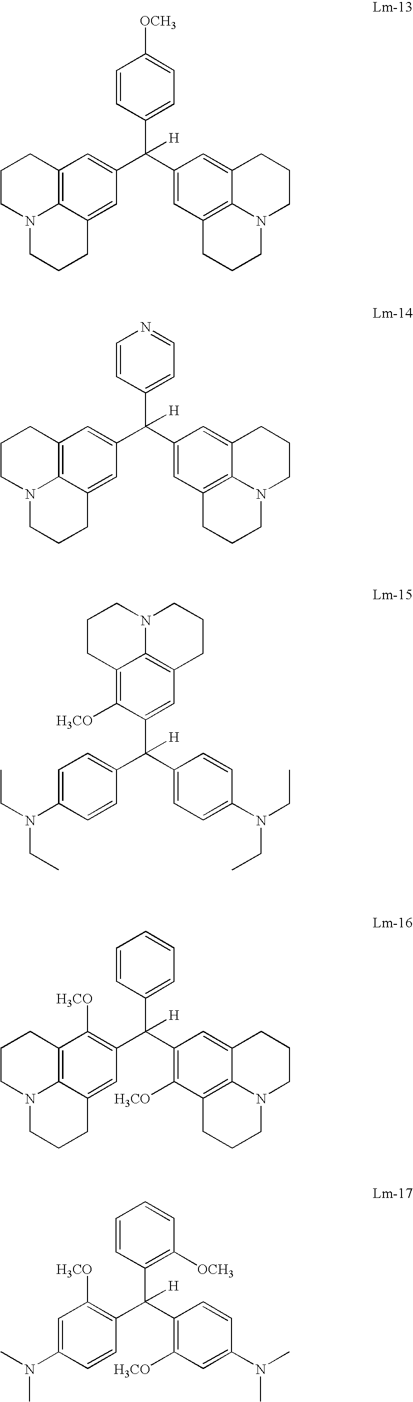

The details of the dye precursors that can be used in the invention are disclosed in JP-A-2005-15699, JP-A-2005-71570, JP-A-2005-100599, and JP-A-2005-320502.

The use amount of the dye precursors is preferably 0.01 to 10 mass % based on the recording layer, and more preferably 0.1 to 5 mass %.

### Other Components:

In the recording layer of the simultaneous two-photon absorption three-dimensional recording medium in the invention, additives such as a chain transfer agent, a thermal stabilizer, a plasticizer, and a solvent may be optionally used according to necessity.

There is a case where it is rather preferred to use a chain transfer agent in the recording layer of the simultaneous two-photon absorption three-dimensional optical recording medium in the invention. Preferred chain transfer agents are thiols, e.g., 2-mercaptobenzoxazole, 2-mercaptobenzothiazole, 2-mercaptobenzimidazole, 4-methyl-4H-1,2,4-triazole-3-thiol, 4,4-thiobisbenzenethiol, p-bromobenzenethiol, thiocyanuric acid, 1,4-bis(mercaptomethyl)benzene, and p-toluenethiol, thiols disclosed in U.S. Pat. No. 4,414,312 and JP-A-64-13144, disulfides disclosed in JP-A-2-291561, thiones disclosed in U.S. Pat. No. 3,558,322 and JP-A-64-17048, O-acylthiohydroxamate, and N-alkoxypyridinethiones disclosed in JP-A-2-291560 are exemplified.

Particularly, when 2,4,5-triphenylimidazolyl dimer is used as the polymerization initiator, it is preferred that the chain transfer agent is used.

The amount of the chain transfer agent used is 1.0 to 30 mass % based on the recording layer.

A composition for forming a recording layer can be prepared according to ordinary methods, for example, the above components and other optional components as they are, or by using a solvent, if necessary.

As the solvents, ketone solvents, e.g., methyl ethyl ketone, methyl isobutyl ketone, acetone, and cyclohexanone, ester solvents, e.g., ethyl acetate, butyl acetate, ethylene glycol diacetate, ethyl lactate, and cellosolve acetate, hydrocarbon solvents, e.g., cyclohexane, toluene and xylene, ether solvents, e.g., tetrahydrofuran, dioxane, and diethyl ether, cellosolve solvents, e.g., methyl cellosolve, ethyl cellosolve, butyl cellosolve, and dimethyl cellosolve, alcohol solvents, e.g., methanol, ethanol, n-propanol, 2-propanol, n-butanol, and diacetone alcohol, fluorine solvents, e.g., 2,2,3,3-tetrafluoropropanol, halogenated hydrocarbon solvents, e.g., dichloromethane, chloroform, and 1,2-dichloroethane, and amide solvents, e.g., N,N-dimethylformamide are exemplified.

The composition can be coated according to an ordinary method to form a recording layer, and there are no particular limitations. The composition can be directly coated on a substrate, or spin coating can be used, or the composition can be cast to obtain a film and laminated on a substrate. The used solvents can be removed by evaporation at the time of drying.

The details of chain transfer agents, thermal stabilizers, plasticizers, and solvents are described in JP-A-5-27436 and JP-A-6-43634.

### Intermediate Layer:

The simultaneous two-photon absorption three-dimensional optical recording medium in the invention has intermediate layers that do not change by a recording light. The intermediate layer reduces crosstalk between two recording layers sandwiching the intermediate layer and at the same time forms the interface with the recording layers, thus it becomes possible to form a reflection signal. Accordingly, it is preferred for the two-photon absorption recording medium of the invention to have an intermediate layer between recording layers.

The materials to form the intermediate layers are not especially restricted, but the materials described, e.g., in Y Kawata et al., Opt. Eng., 40 (10), 2247-2254 (2001), Masahito Nakabayashi, Optronics, p. 168 (July 2005), and JP-A-2008-262650 are exemplified. In particular, polyvinyl alcohol, acrylic acid containing a crosslinking agent, and copolymers comprising hydroxyethyl methacrylate, or glycidyl methacrylate with acrylate or methacrylate having alkyl ester having 2 to 12 carbon atoms are preferred.

The forming method of the intermediate layer is not especially restricted, and it is preferred to form the intermediate layer by spin coating of the composition for forming the intermediate layer.

The thickness of the intermediate layer is not especially limited, but is preferably 0.5 to 10 μm, and more preferably 1 to 5 μm.

### EXAMPLE

The invention will be described specifically with reference to examples. The invention is of course not restricted to these examples.

### Computation of Increasing Amount of Necessary Sensitivity:

As an example of computation of increasing amount of necessary sensitivity, values approaching actual condition, i.e., Rₛ=0.05, Rₜ=R_{b}=0.01 are substituted for expression (1) to obtain the value of expression (1). The results obtained are shown in Table 1 below.

TABLE 1
Increasing amount of necessary sensitivity computed from
expression (1)

| | The Value of |
|---|---|
| n | Expression (1) |
| 1 | 1.00 |
| 2 | 1.02 |
| 3 | 1.03 |
| 4 | 1.05 |
| 5 | 1.07 |
| 6 | 1.08 |
| 7 | 1.10 |
| 8 | 1.12 |
| 9 | 1.13 |
| 10 | 1.15 |
| 11 | 1.16 |
| 12 | 1.18 |
| 13 | 1.19 |
| 14 | 1.20 |
| 15 | 1.22 |
| 16 | 1.23 |
| 17 | 1.24 |
| 18 | 1.26 |
| 19 | 1.27 |
| 20 | 1.28 |

### Preparation of Coating Solution 1 for Recording Layer:

Coating solution 1 for the recording layer of the two-photon absorption three-dimensional recording medium of the invention is prepared with the following composition.

### Composition of Coating Solution 1 for the Recording Layer of the Two-Photon Recording Medium:

| | |
|---|---|
| Two-photon absorption compound | 0.02 g |
| (exemplified compound D-94) | |
| Polymerization initiator (I-54 shown below) | 0.03 g |
| Polymerizable compound (M-1 shown below) | 1.15 g |
| Binder (cellulose acetate-butyrate (CAB)) | 1.25 g |
| Chain transfer agent (I-57 shown below) | 0.045 g |
| Solvent (dichloromethane) | 14.6 g |

I-54

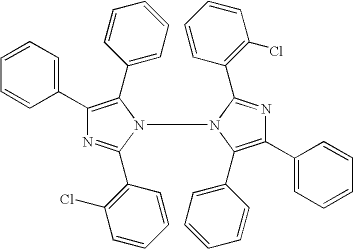

I-57

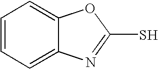

M-1

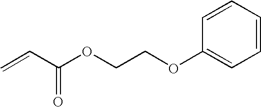

### Preparation of Coating Solution 2 for Recording Layer:

Coating solution 2 for a recording layer is prepared with the same composition as used in coating solution 1 except for increasing the addition amount of two-photon absorption compound D-94 by 5%.

### Preparation of Coating Solution 3 for Recording Layer:

Coating solution 3 for a recording layer is prepared with the same composition as used in coating solution 1 except for increasing the addition amount of two-photon absorption compound D-94 by 10%.

### Preparation of Coating Solution 4 for Recording Layer:

Coating solution 4 for a recording layer is prepared with the same composition as used in coating solution 1 except for increasing the concentrations of the polymerization initiator I-54 and the chain transfer agent I-57 by 10%, respectively.

### Preparation of Coating Solution 5 for Recording Layer:

Coating solution 5 for a recording layer is prepared with the same composition as used in coating solution 1 except for increasing the concentration of the polymerizable compound M-1 by 15%.

### Preparation of Coating Solution 6 for Recording Layer:

Coating solution 6 for the recording layer of a two-photon absorption three-dimensional recording medium is prepared with the following composition.

| | |
|---|---|
| Two-photon absorption compound | 0.015 g |
| (exemplified compound D-133) | |
| Dye precursor (Lo-11) | 0.0017 g |
| Polymer binder (polyvinyl acetate) | 1.0 g |
| Solvent (dichloromethane) | 28.8 g |

D-133

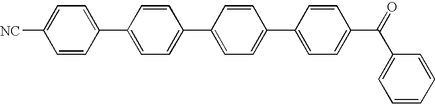

### Preparation of Coating Solution 7 for Recording Layer:

Coating solution 7 for a recording layer is prepared with the same composition as used in coating solution 6 for the recording layer except for increasing the addition amount of the dye precursor Lo-11 by 25%.

### Preparation of Coating Solution 8 for Recording Layer:

Coating solution 8 for a recording layer is prepared with the same composition as used in coating solution 6 for the recording layer except for increasing the addition amount of the same dye precursor Lo-11 as used in coating solution 6 for the recording layer to 2.5 times.

Evaluation of Sensitivity of a Single Layer Recording Layer Prepared with Each Coating Solution:

Each of the above coating solutions 6 to 8 for recording layer is coated on a glass plate for preparation by a spin coating method to form a single layer recording layer having a thickness of about 1 μm. Recording by two-photon absorption is performed by converging second harmonic 522 nm of femto-second laser of 1,045 nm (pulse duration: 200 fs, repetition: 2.85 GHz, peak power: 1 kW) with a lens of NA 0.8 on each recording layer obtained above. For the reproduction of the recorded information, the recording layer is irradiated with an He—Ne laser beam of 633 nM by means of a confocal microscope, and fluorescent strength obtained at this time is measured with a photomultiplier. Recording on each recording layer is performed on a constant condition of irradiation power and irradiation time of the recording laser beam. Fluorescent signal strength obtained from the formed record pits is evaluated as the voltage of the photomultiplier.

The signal strength of the single layer recording layer obtained with each coating solution is shown in Table 2 below. Relative sensitivity is a relative value when the signal strength (voltage of the photomultiplier) of the recording layer obtained with coating solution 6 is taken as 1.

TABLE 2

| Coating Solution | Signal Strength (V) | Relative Sensitivity |
|---|---|---|
| Coating solution 6 | 4.63 | 1.0 |
| Coating solution 7 | 5.34 | 1.15 |
| Coating solution 8 | 5.96 | 1.29 |

### Example 1

### Manufacture of Multilayer Recording Medium 1

The above coating solution 1 for a recording layer is coated on a glass plate for preparation by a spin coating method to form a recording layer having a thickness of about 1 μm. After allowing the layer to stand in a dark place and drying, a polyvinyl alcohol aqueous solution is coated on the recording layer by spin coating to form an intermediate layer having a thickness of about 5 μm. After repeating coating of coating solution 1, coating of polyvinyl alcohol, and drying for three times, coating solution 1 is changed to coating solution 2, and further three layers of recording layers and intermediate layers are formed. After that, coating solution 2 is changed to coating solution 3, and further three layers of recording layers and intermediate layers are formed to manufacture a two-photon three-dimensional optical recording medium having nine layers in total of recording layers and intermediate layers respectively.

### Example 2

### Manufacture of Multilayer Recording Medium 2

A two-photon three-dimensional optical recording medium having nine layers in total of recording layers and intermediate layers respectively is manufactured in the same manner as in the manufacture of multilayer recording medium 1 except for forming recording layers of the first layer to the sixth layer with coating solution 1, and recording layers of the seven^{th} layer to the nin^{th} layer with coating solution 4.

### Example 3

### Manufacture of Multilayer Recording Medium 3

A two-photon three-dimensional optical recording medium having nine layers in total of recording layers and intermediate layers respectively is manufactured in the same manner as in the manufacture of multilayer recording medium 1 except for forming recording layers of the first layer to the sixth layer with coating solution 1, and recording layers of the seven^{th} layer to the nin^{th} layer with coating solution 5.

### Comparative Example 1

### Manufacture of Multilayer Recording Medium 1 for Comparison

Multilayer recording medium 1 for comparison is manufactured in the same manner as in the manufacture of multilayer recording medium 1 except for using coating solution 1 for all of the nine layers of recording layers.

### Evaluation of Multilayer Recording Medium:

In two-photon recording on the multilayer recording media in the invention, Ti:sapphire laser (pulse duration: 100 fs, repetition: 80 MHz, average output: 1 W, peak power: 100 kW) wavelength-variable in the wavelength range of 700 nm to 1,000 nm is used. Recording is performed on the two-photon three-dimensional multilayer recording media of Examples 1 to 3 and Comparative Example 1 by converging the laser beam with a lens of NA 0.6. The wavelength used in recording is 780 nm. In reading of the recorded information, a semiconductor laser of 780 nm is used. Each recording layer is scanned by means of a confocal microscope, and the distribution of the reflected light strength that can be obtained at that time is observed as a two-dimensional image. Recorded marks are formed on the recorded part, and reflected light strength is increased as compared with the unrecorded part. In the first place, recording is performed on the first layer of the recording layers, and the diameter of the recorded mark in the obtained recorded and reproduced image is measured. The recording light strength giving the diameter of recorded marks of about 1 μm is taken as standard recording light strength in each medium. In multilayer recording, information recording on each layer is performed by using the recording light strength obtained like this.

As a result of multilayer recording and reproduction on each recording medium, in multilayer recording medium 1 in Example 1, recorded marks having a diameter of about 1 μm can be substantially observed in all of the nine layers.

In multilayer recording medium 2 in Example 2, the diameters of recorded marks of the first layer to the sixth layer are decreased, but in seven^{th} layer where recording sensitivity is increased, recorded mark having the same degree of the diameter of recorded marks recorded on the first layer can be observed.

In multilayer recording medium 3 in Example 3, the decrease of the diameters of recorded marks is observed with the advance in the depth direction from the first recording layer to the sixth layers, but a recorded mark having a diameter larger than the diameter of the recorded mark recorded on the first layer is observed on the seven^{th} layer.

Contrary to this, in multilayer recording medium 1 in Comparative Example 1, the decrease of the diameters of the recorded marks is observed with the advance deeper in the depth direction, and the diameter of the recorded mark cannot be substantially observed on the nin^{th} layer.

### Example 4

### Manufacture of Multilayer Recording Medium 4

A two-photon three-dimensional optical recording medium having twenty layers in total of recording layers and intermediate layers respectively is manufactured by forming recording layers of the first layer to the sixth layer with coating solution 6, recording layers of the seven^{th} layer to the fourteen^{th} layer with coating solution 7, and recording layers of the fifteen^{th} layer to the twentieth layer with coating solution 8.

### Comparative Example 2

### Manufacture of Multilayer Recording Medium 2 for Comparison

Multilayer recording medium 2 for comparison is manufactured in the same manner as in the manufacture of multilayer recording medium 4 except for using coating solution 6 for all of the twenty layers of recording layers.

### Evaluation of Multilayer Recording Medium:

In two-photon recording on multilayer recording medium 4, second harmonic 522 nm of femto-second laser of 1,045 nm (pulse duration: 200 fs, repetition: 2.85 GHz, peak power: 1 kW) is used. Recording is performed on two-photon three-dimensional multilayer recording media in Example 4 and Comparative Example 2 by converging the laser beam with a lens of NA 0.8. In the reproduction of recorded information, an He—Ne laser beam of 633 nm is used. Each recording layer is scanned by means of a confocal microscope, and the distribution of the fluorescent strength obtained at this time is observed as a two-dimensional image. Recorded marks are formed on the recorded part, and fluorescent strength is increased as compared with the unrecorded part. In the first place, recording is performed on the first layer of the recording layers, and the diameter of the recorded mark in the obtained recorded and reproduced image is measured. The recording light strength giving the diameter of the recorded mark of about 1 μm is taken as standard recording light strength in each medium. In multilayer recording, information recording on each layer is performed by using the recording light strength obtained like this.

As a result of multilayer recording and reproduction on each recording medium, in multilayer recording medium 4 in Example 4, recorded marks having a diameter of about 1 μm can be substantially observed on all of twenty layers as fluorescent signals.

Contrary to this, in multilayer recording medium 2 for comparison in Comparative Example 2, decrease of the diameters of the record marks is observed with the advance deeper in the depth direction, and observation of the fluorescent signal is substantially impossible on and after the seven^{th} layer.

According to the constitution of the invention, in a two-photon absorption three-dimensional optical recording medium having a multilayer structure, reduction of recording sensitivity can be prevented by increasing the sensitivities of recording layers in the depth direction in the advancing direction of a recording light even when a recording light that weakens at a deep part due to reflection at the interfaces of the layers is used.

The entire disclosure of each and every foreign patent application from which the benefit of foreign priority has been claimed in the present application is incorporated herein by reference, as if fully set forth.

What is claimed is:

1. A simultaneous two-photon absorption three-dimensional optical recording medium for recording three-dimensionally record pits in the recording medium by simultaneous two-photon absorption and reading these recorded record pits, which has a multilayer structure prepared by laminating recording layers and intermediate layers, wherein information is recorded on the recording layers by simultaneous two-photon absorption, the intermediate layers do not change by a recording light, and sensitivities of a part of or all of the recording layers are different.

2. The simultaneous two-photon absorption three-dimensional optical recording medium as claimed in claim 1, wherein
the sensitivities of a part of or all of the recording layers are increasing from a nearer side to a farther side in an advancing direction of a recording light.

3. The simultaneous two-photon absorption three-dimensional optical recording medium as claimed in claim 1, wherein
sensitivities of adjacent two recording layers are the same, or a sensitivity of the recording layer on the farther side in the advancing direction of the recording light is higher than a sensitivity of the recording layer on the nearer side in the advancing direction of the recording light.

4. The simultaneous two-photon absorption three-dimensional optical recording medium as claimed in claim 1, wherein
a sensitivity of a n^{th} recording layer in the advancing direction of the recording light is higher than a sensitivity of the nearest recording layer in the advancing direction of the recording light by X times or more, wherein X is represented by the following expression (1):
X=[2−(1−Rₛ)(1−Rₜ)ⁿ(1−R_{b})ⁿ⁻¹]/(1+Rₛ+Rₜ−RₛRₜ) (1)
wherein
Rₛ represents a reflectance at a surface of the medium and is a real number of or greater and 1 or smaller;
Rₜ represents a reflectance at a top face of the recording layer in the advancing direction of the recording light and is a real number of 0 or greater and 1 or smaller;
R_{b} represents a reflectance at a bottom face of the recording layer in the advancing direction of a recording light and is a real number of 0 or greater and 1 or smaller; and
n is an integer indicating to be the n^{th} recording layer in the advancing direction of the recording light.

5. The simultaneous two-photon absorption three-dimensional optical recording medium as claimed in claim 1, wherein
the recording layers contain at least a two-photon absorption compound, a polymerization initiator, a polymerizable compound, and a polymer binder.

6. The simultaneous two-photon absorption three-dimensional optical recording medium as claimed in claim 1, wherein
the recording layers contain at least a two-photon absorption compound, a dye precursor and a polymer binder.

7. The simultaneous two-photon absorption three-dimensional optical recording medium as claimed in claim 3, wherein
the sensitivity of the recording layer on the farther side in the advancing direction of the light is increased by increasing a concentration of a two-photon absorption compound.

8. The simultaneous two-photon absorption three-dimensional optical recording medium as claimed in claim 3, wherein
the sensitivity of the recording layer on the farther side in the advancing direction of the light is increased by increasing a concentration of a polymerization initiator.

9. The simultaneous two-photon absorption three-dimensional optical recording medium as claimed in claim 3, wherein
the sensitivity of the recording layer on the farther side in the advancing direction of the light is increased by increasing a concentration of a polymerizable compound.

10. The simultaneous two-photon absorption three-dimensional optical recording medium as claimed in claim 3, wherein
the sensitivity of the recording layer on the farther side in the advancing direction of the light is increased by increasing concentrations of all of or any two of a two-photon absorption compound, a polymerization initiator and a polymerizable compound.

11. The simultaneous two-photon absorption three-dimensional optical recording medium as claimed in claim 6, wherein
the sensitivity of the recording layer on the farther side in the advancing direction of the light is increased by increasing a concentration of the dye precursor, or by increasing concentrations of both of the two-photon absorption compound and the dye precursor.

12. A method of simultaneous two-photon three-dimensional optical recording, comprising:
inducing a simultaneous two-photon absorption on the simultaneous two-photon absorption three-dimensional optical recording medium as claimed in claim 1 to record information three-dimensionally.
